(19) United States
(12) Patent Application Publication
(10) Pub. No.: US 2009/0205470 A1
(43) Pub. Date: Aug. 20, 2009

(54) Coated guided pad for saw blades

(76) Inventors: Edward McComas, Palm City, FL (US); Dennis Hanlen, Palm Beach Gardens, FL (US)

Correspondence Address: Sam Silverberg, 6820 32nd st. NW, Washington, DC, 20015, US

(21) Appl. No.: 12/071,171

(22) Filed: Feb. 15, 2008

(51) Int. Cl. B26D 7/00; B27B 11/02

(52) U.S. Cl. 83/13; 83/823

(57) ABSTRACT

Guide pads with electroless nickel coatings provide a better wear resistance and a lower coefficient of friction than the Babbitt guide pad material. The unexpected benefit is that when the electroless nickel coating comes into contact with the rotating saw blade body the damage to the pad or saw blade or both is substantially reduced. Also the effect of hydraulic erosion or third body erosion is minimal. With a nickel boron coating on a set of guide pads made of AMS-5069-1018 steel, at least 600 hours of use was achieved without failure of the pad or damage to the saw blade body

### FIELD OF INVENTION

This invention relates to an electroless nickel coated guide pad that can be adjusted while the guide pad is mounted on the guide arm.

### BACKGROUND OF THE INVENTION

Guides and their associated guide pads are used to control circular and/or band saw blades to minimize deviation from the cutting plane. A saw blade has a tendency to deflect under heat. U.S. Pat. No. 4,635,513, incorporated by reference in the entirety, teaches that the heat is caused by the friction of the blade rubbing against the saw blade guide. This reference teaches that water or oil or a mixture of oil and water can be inserted between the bearing surface of the guide plate and the saw plate to cool the saw blade. The prior art has provided a mixture of forced air, water, and oil to be distributed onto the saw blade through drilled hole in the guide while the blade is in operation. In this manner, the liquid under pressure forms a film on the guide bearing surface and acts to keeps the saw blade stable and to minimizes deflection.

U.S. Pat. No. 7,013,779, incorporated by reference, in the entirety shows the use of saw blade guide pads attached to a guide arm to form a guided blade assembly. These guided saw blade assemblies are normally comprised of a lubricating guide support assembly that includes two guide pads per saw blade each having a liquid bearing surface located immediately adjacent to each other on both sides of the saw body. Clearance between the saw blade body and guide pad is minimal (e.g., 0.0001 to 0.005″) but still allowing for free rotation with exception of unintentional and occasional contact with the guide pad while in use. At least one of the guide support pads includes a concave area containing pressurized liquid exposed to the saw blade body. The pressurized liquid is designed to cool the saw blade while also providing hydraulic support of equal pressure to both sides of saw blade body The pressurized liquid acts as a liquid bearing that prevents all but occasional contact of the saw with the guide pad.

The guides are usually positioned perpendicular to an arbor and the saw blade must rotate parallel to the guides. Excessive distance between the guides will result in increased saw body deflection and increased sawing variation. Inadequate distance between the guides will cause the guide and saw body to heat and wear. The heat will distort the relatively thin saw body leading to excessive saw deviation and potential destruction of the saw.

Typically guide pads are produced from relatively soft and/or pliable materials such as Babbitt type alloys made of but not limited to tin-antimony-nickel. The alloy is poured into a mold in the shape of the pad. The pad is then bolted to the guide arm, and machined to the finished thickness. These guide pads are able to accept occasional contact with the saw blade without causing damage to the saw blade body.

In operation a guide pad assembly uses a large volume of water under pressure to cool and support the saw blades. The high volume and pressure of the water passing through the system is known to be erosive to the soft guide pad materials. In addition, the occasional contact between the guide pad and saw blade body or cut debris such as wood fibers and saw dust traveling at a high rate of impact speed can cause damage to the pad.

The prior art has tried to use different materials to make the guide pads. Materials such as steel or other metals have not worked in the past due to the inherent friction and galling created by the metallic saw blades rubbing against the guide pads. Others in the art have tried chrome plated guide pads, bronze/Teflon pads, and ceramic guide pads.

These guide pads including the Babbitt pads are usually attached to the guide arm and then milled, or machined or shaved to the desired distance from the guide arm. After the guide pads become worn and are no longer at the desired distance form the guide arm, they are usually discarded. The Teflon/bronze pad can be reused by shimming the pad while attached to the guide arm and then re-milling the surface. None of these pads have been shown to be an effective commercial substitute for the Babbitt guide pads.

The prior art has acknowledged that the use of Babbitt pads are a problem in the art. Babbitt pads require a special room and equipment for manufacturing and usually a dedicated person for molding the Babbitt and servicing the Babbitt pad. Also Babbitt pads generate hazardous fumes during their manufacture because of the antimony contained in the alloy. Due to softness and low heat and abrasion resistance of the Babbitt metal, the expected life of a Babbitt pad is relatively short. Typically useful life is from 4 to 60 hours of operation.

The prior art has acknowledged that a longer life guide pad would solve a long felt need in the art. Replacing the Babbitt pads, with pads that would have a longer service life would result in a substantially economic benefit due to less variation and improved recovery. The saw blade would have limited opportunity to distort. Also a more stable guide pad would reduce the ability of the blade to deflect and increase lumber yields. Narrower tolerances on the distance from the guide arm to the guide pad could be expected to reduce the consumption of water and oil.

### SUMMARY OF INVENTION

Guide pads with electroless nickel coatings provide a better wear resistance and a lower coefficient of friction than the Babbitt guide pad material. The unexpected benefit is that when the electroless nickel coating comes into contact with the rotating saw blade body the damage to the pad or saw blade or both is substantially reduced. Also the effect of hydraulic erosion or third body erosion is minimal. With a nickel boron coating on a set of guide pads made of AMS-5069-1018 steel, at least 600 hours of use was achieved without failure of the pad or damage to the saw blade body. In contrast, on the same equipment the Babbitt pads needed to be changed every 60 hours. It has also been found that coating the saw blade with an electroless nickel boron coating provides unexpected results. The invention is not limited to electroless nickel coatings. All coatings that have at least similar properties as electroless nickel coatings would be expected to work. These properties include wear resistance and lubricity.

### DESCRIPTION OF THE PREFERRED EMBODIMENT

The present invention provides a guide pad that is coated with an electroless nickel coating. Preferably the coating is an alkaline electroless nickel boron coating. The guide pad can be made of a hard material such as but not limited to hot and cold rolled steel, aluminum, bronze, titanium, stainless steel, powdered metal, cast iron and high strength plastics. The pad can be produced from any conventional method such as but not limited to sand casting, investment casting, centrifuge casting, loss-foam casting, loss wax casting machined from billet, forged, sintered or molded. After the pad is produced the pad is usually polished. The electroless nickel coating is applied using conventional electroless nickel processes. U.S. Pat. No. 6,066,406 to McComas, granted May 23, 2000; U.S. Pat. No. 6,183,546 to McComas, granted Feb. 6, 2001; U.S. Pat. No. 6,319,308 to McComas, granted Nov. 20, 2001; and U.S. Pat. No. 6,782,650 to McComas, granted Apr. 31, 2004, all of which are incorporated by reference in their entirety. The coating is usually 0.0005 to 0.005 inch.

In a preferred embodiment an electroless nickel boron coating was applied to a machined steel pad with an electroless nickel boron coating. These coated guide pads can be positioned with minimal guide clearance (e.g., 0.001-0.002 inch) without causing excessive heat or friction.

### Experiment

The following experiment was made to contrast the benefits obtain using a conventional Babbitt (tin/antimony alloy) pad and an electroless nickel boron coated pad. A saw blade guide pad was produced from A-01 steel with a Knoop hardness averaging 110-121-Kh @ 25 gram load. A guide pad was produced from a conventional Babbitt (tin/antimony alloy) averaging 21-23 Kh @ 25 gram load. Prior to plating, the steel guide pads were placed in a vibratory bowl for 2 hours using a ceramic media to remove burrs and other slight surface imperfections such as tooling marks.

Electroless Nickel Example; sodium borohydride was selected as the reducing agent. A 200 gallon electroless nickel boron bath was made as follows;
1. Plating tank was filled half-way with deionized water.
2. About 88 kilos of nickel chloride was added, pump and filter system was activated allowing solution to mix.
3. To the bath, about 220 kilos of ethylenediamine was added and allowed to mix.
4. To the bath, about 50 lbs of sodium hydroxide was added.
5. The plating tank was toped-off at the 200 gallon level using deionized water and heater was set at 195° F.
6. Just prior to placing the guides in the bath; 120 grams of sodium borohydride, 300 grams of sodium hydroxide and 2.3 grams of lead tungstate were mixed and added to the bath. This addition was repeated every 30 minutes of plating.

### Application of the an Alkaline Electroless Nickel Boron Coating;

1. The steel guide pad was first vapor degreased to ensure removal of machining oil and soil from the surface.
2. The pad was next grit blasted all over using aluminum oxide.
3. After grit blasting, the pad was attached to a universal plating rack and placed in a common soak detergent type cleaner for 3-5 minutes.
4. After soak clean, the pad was placed in an acid salt bath to remove any residual surface oxides and to initiate surface activation.
5. After acid activation, the pad was thoroughly rinsed in deionized water
6. Placed in the plating tank for a period of 2½ hours for a final thickness of 50 microns.
7. After plating, the pad was heat treated at 725° F. for 90 minutes to increase hardness and abrasion resistance.

After plating and heat treatment, the pads were again placed in a vibratory bowl to remove surface oxidation as the result of heat treating and to polish the pad.

The beta-site chosen for the controlled test had an established history of changing Babbitt guide pads after 60 hours of use due to damaged caused by the combination of occasional contact with the saw blade body, third body abrasive wear and hydraulic erosion. A test set of guide pads made of AMS-5069-1018 (01 Steel) steel plus an electroless nickel boron coating performed for 600 hours without failure of the pad or damage to the saw blade body. Also unexpected results have been obtained using coated guide pads with electroless nickel boron coated saw blades.

The benefits of an electroless nickel boron coated compared to a Babbitt guide pad are as follows:
1) Longer guide run time on the machine (up to 10× more life) due to reduced friction, galling, heat, etc. Reduced unscheduled downtime results in increased mill profits.
2) Longer run time of the saw blade due to less friction, galling, heat, etc. Saw blades last longer due to less plate wear around the guides and less bending stresses
3) Highly lubricious surface reduces pitch and resin build-up thereby keeping saw blade cooler and facilitating easy cleaning of blades. Coating also offers corrosion protection when cutting corrosive woods such as Western red cedar.
4) The coating's ability to reduce heat results in less work needed to level and/or tension the saw body.
5) A reduction in heat generated by cutting may be realized. Less heat results in improved sawing accuracy, increased stiffness, and reduced sawing variation. Reduced sawing variation allows mills to decrease their target size. It also reduces sawing defects such as taper, wedging, snaking, flaring, etc.
6) Reduced guide clearance tolerances can be obtained due to superior machining properties of steel versus a Babbitt guide pad (coated steel pad can be provided with a more uniform smoothness and dimensions than a Babbitt pad.
7) The use of electroless nickel coated pads benefits allows the use of thinner saw plate (e.g., 0.090 instead of 0.100″) thereby increasing lumber yield and mill profits
8) Reduced oil lubrication consumption would be expected due to the highly lubricious surface of the coating, reduced heat absorption into the saw body, and reduced saw deflection. Reducing oil consumption increases mills profits and reduces environmental waste concerns.

In normal operation the coated guide pad is attached to a guide arm used the using the techniques described in U.S. patent application Ser. No. ______ filed on the same date as this application titled Adjustable Guide Pads, invented by Larry Baker and Michael Halterman which is incorporated by reference in the entirety. The guide pad is provided with holes where adjusting screws or retaining screws can be inserted to allow the pad to be attached to a guide arm. After the coating becomes worn the pad can be resurfaced and can be recoated. To increase the life of the pad each side of the pad can be fabricated to face a saw blade so the blade can be reversed when a side becomes worn.

The ability of the coating to withstand the process conditions of saw application depends on the quality of the coating. The experiments showed that improperly coated pads can shorten the life of the guide pad.

1. A saw blade guide pad that can be attached to a guide arm for stabilizing a saw blade comprising
a guide pad having a coating that has properties of wear resistance and lubricity that is substantially the same or exceed those of an electroless nickel coating.
means to attach the pad to the guide arm.

2. A saw blade guide pad according to claim 1 wherein the coating is an electroless nickel coating.

3. A saw blade guide pad according to claim 2 wherein the electroless nickel coating is an alkaline nickel boron coating.

4. A saw blade guide pad according to claim 1 wherein the coating is about 0.0005 to about 0.005 inch thick.

5. A saw blade guide pad according to claim 1 wherein said guide pad has a recessed pocket for fluid flow.

6. A saw blade guide pad according to claim 2 whereas the electroless nickel was reduced with either sodium borohydride or sodium hypophosphite.

7. A saw blade guide pad according to claim 1 whereas the coating contains co-deposited particles selected from the group consisting of polytetraflorethylene (PTFE), cubic boron nitride (CBN), Diamond like carbon (DLC), tungsten disulfide and molybdenum disulfide.

8. A saw blade guide pad according to claim 1 where in the means to attach the guide pad to the guide arm include holes to receive retaining screws or leveling screws to level and retain the pad on the guide arm.

9. A saw blade guide pad attached to a guide arm for stabilizing a saw blade comprising
a guide arm having mean to attach the guide pad to the guide arm and
a guide pad having an electroless nickel coating, and
means to adjust the guide pad for leveling and positioning the guide pad to the guide arm.

10. A saw blade guide pad according to claim 9 wherein the electroless nickel coating is an alkaline nickel boron coating.

11. A saw blade guide pad according to claim 9 wherein said guide pad has a recessed pocket for fluid flow.

12. A saw blade guide pad according to claim 9 wherein said means to attach said guide pad to said guide arm includes a threaded opening in the guide arm to receive retaining screws which are inserted through holes in the guide pad.

13. A process of stabilizing a saw blade with coated guide pads comprising
providing a guide arm
providing a coated guide pad wherein the coating has properties of wear resistance and lubricity that is substantially the same or exceed those of an electroless nickel coating providing an adjustable leveling means for leveling the guide pad and locking the guide pad into a fixed level position with respect to the guide arm,
leveling the guide pad until the desired distance from the guide arm is reached,
locking the guide pad to the guide arm.

14. A process according to claim 13 wherein the coating is an electroless nickel coating.

15. A process according to claim 14 wherein the coating is an alkaline nickel boron coating.

16. A process according to claim 13 wherein the saw blade has been coated with an electroless nickel coating.

17. A process according to claim 16 wherein the saw blade has been coated with an electroless nickel boron coating.
